(19) United States
(12) Patent Application Publication
(10) Pub. No.: US 2002/0054685 A1
(43) Pub. Date: May 9, 2002

(54) System for suppressing acoustic echoes and interferences in multi-channel audio systems

(76) Inventors: Carlos Avendano, Campbell, CA (US); Mark Dolson, Ben Lemond, CA (US); Jean LaRoche, Santa Cruz, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/956,476

(22) Filed: Sep. 17, 2001

Related U.S. Application Data
(60) Provisional application No. 60/247,670, filed on Nov. 9, 2000.

(51) Int. Cl. H04B 3/20

(52) U.S. Cl. 381/66; 379/406.01

(57) ABSTRACT

A method for obtaining a clean speech signal in a communication system having a transducer for receiving a clean speech signal from a user and having a pair of loudspeakers for providing an output signal to the user. The output signal contains loudspeaker signals which interfere with the clean speech signal, the loudspeaker signals traveling through acoustic paths to reach the transducer. The transducer receives an input signal containing the loudspeaker signals and the clean speech signal. The method includes a number of steps, namely, performing a short time Fourier transform (STFT) on the input signal to obtain at least one frequency component, performing a short time Fourier transform (STFT) on the loudspeaker signals to obtain frequency components, summing the frequency components to obtain an interference sum, and subtracting the interference sum from the at least one frequency component to obtain the clean speech signal for translation into a time domain.

### CLAIM OF PRIORITY

The present application claims priority from U.S. Provisional Patent Application Serial No. 60/247,670, entitled “Multi-Channel Acoustic Interference and Echo Suppressor,” filed on Nov. 9, 2000.

### BACKGROUND OF THE INVENTION

The present invention relates generally to the field of digital signal processing and specifically to acoustic echo canceler systems.

Conventional AEC (acoustic echo canceler) systems for canceling undesired echoes in communication systems are well known. The undesired echoes are a result of acoustic coupling within the communication system. FIG. 1A is a block diagram of a communication system 100 illustrating the problem of acoustic coupling. As shown, communication system 100 is monaural, consisting essentially of a single loudspeaker 102 and a single microphone 104. Examples of monaural systems are teleconferencing systems, hearing aid systems and hands-free telephony systems.

Using microphone 104, a user 108 transmits a speech signal 106 to a remote location where it received by a remote user (not shown). In a similar fashion, sound originating from the remote location is transmitted and received from loudspeaker 102, where it is perceived by the user. Herein lies the problem of acoustic coupling. When speech is transmitted to the remote location, microphone 104 captures undesired sound emanating from loudspeaker 102 resulting in transmission of speech 106 as well as the undesired sound. This phenomenon is referred to as acoustic coupling. When the undesired sound is a voice stream, the sound is transmitted to the remote user where it is perceived as an echo. Other undesired signals such as ambient noise within the room are captured and transmitted with the desired signal resulting in a corrupted signal.

A number of conventional AEC systems have been developed to resolve the aforementioned problem. One system employs the impulse response of the acoustic coupling and produces a signal for canceling the echo. Another system estimates a transfer function for the acoustic path between the loudspeaker and the microphone. As shown in FIG. 1B, the system consists of a filter g(t) that is adapted to estimate the acoustic path h(t) between loudspeaker 102 and microphone 104. The loudspeaker signal x(t) is passed through filter g(t) and the result is subtracted from the microphone output y(t) as shown in FIG. 1B. The filter adaptation is done in real time using a recursive algorithm, for example. In practice, the canceler is adapted only during non-speech intervals (s(t)=0). When the receiving room becomes the transmitting room, the situation is reversed.

While varying degrees of success have been achieved by applying this solution to monaural systems, its effectiveness relative to stereophonic and multichannel systems has remained doubtful. As shown, FIG. 2 is a block diagram of such a multichannel system 200 for enabling a user 218 to communicate with a remote user (not shown) through a data communication channel (not shown). Specifically, system 200 is a desktop environment. Unlike monaural systems, system 200 has two or more loudspeakers 214, 204 within the desktop environment.

A fundamental reason why solutions to monaural systems are ineffective in multichannel systems is because of the “non-uniqueness” problem, which is the inability to isolate the contributions of one signal (undesired) emanating from the two or more loudspeakers within a multi-channel system. The problem arises because the microphone captures the sum of the two or more signals, each signal arriving at the microphone via a different acoustic path, each signal being modified by its acoustic path. Therefore, it is difficult to obtain the true transfer function for each acoustic path to approximate the undesired signal.

Other techniques have been proposed to overcome the non-uniqueness problem. In one technique, distortion (e.g., nonlinearity) is applied to the loudspeaker signals in order to de-correlate them and to identify the acoustic paths. In an alternate technique employed within a hands-free communication method for a multichannel transmission system, a coupling estimator for a single-channel transmission serves to determine the acoustic coupling between loudspeaker and microphone. Between each microphone and each loudspeaker, the respective acoustic coupling factors and the respective coupling factors determined for a microphone are weighted with the short time average of the received signal of the loudspeaker associated with the respective coupling factor.

After, the signals are de-correlated, the estimates of the transfer function for each acoustic path is obtained in the time domain. Thereafter, an interference signal is estimated in the time domain, and cancelled from the microphone output signal. The interference signal is typically cancelled in a sample-by-sample fashion. Disadvantageously, this process employed in conventional multichannel AEC systems, typically results in undesirable loss of audio quality. Furthermore, conventional systems are sensitive to misalignment in the acoustic path estimates, and since the interference is canceled in sample-by-sample fashion, errors in the estimate will result in poor cancellation. Other factors such as changes in ambient conditions typically result in poor system performance in conventional AEC systems.

Therefore, there is a need to resolve the aforementioned problems relating to conventional multichannel AEC systems.

### SUMMARY OF THE INVENTION

A first aspect of the present invention discloses a method for suppressing an interference signal from a microphone output signal in order to obtain a clean speech signal.

Typically, the interference signal contains loudspeaker signals that travel through acoustic paths to the microphone. The acoustic paths modify the loudspeaker signals which combine to form the interference signal upon arrival at the microphone. At this point, interference signal combines with the clean speech signal (e.g. from a user) to form the microphone output signal. Therefore, the objective is to extract the clean speech signal from the microphone signal. The method involves the steps of determining an acoustic response for each of the acoustic paths, and determining an estimate of the interference signal in the frequency domain using the acoustic response for each of the acoustic paths. Thereafter, the steps of suppressing the estimate of interference signal from the microphone output signal to obtain the clean speech signal in the frequency domain and translating the clean speech signal into time domain are employed.

In an alternate aspect, the present invention teaches a method for obtaining a clean speech signal in a communication system. The communication system has a transducer for receiving the clean speech signal from a user, and a set of loudspeakers for providing an output signal to the user. The output signal contains loudspeaker signals which interfere with the clean speech signal, the loudspeaker signals travel through acoustic paths to reach the transducer. The loudspeaker signals and the clean speech signal are part of an input signal received by the transducer.

To obtain the clean speech signal, the present embodiment performs a short-time Fourier transform (STFT) on the input signal to obtain at least one frequency component, and performs a short-time Fourier transform (STFT) on the loudspeaker signals to obtain frequency components. The method combines the frequency components to obtain an interference sum and then subtracts the interference sum from at least one frequency component to obtain the clean speech signal for translation into a time domain.

In a further embodiment, the present invention discloses a system for suppressing an interference signal in a communication system. The communication system has a local microphone for transmitting signals to a remote user through a communication channel, and local loudspeakers for receiving signals from the remote user via the communication channel. The microphone receives a microphone output signal including a clean speech signal from a local user and an interference signal from the loudspeakers.

The system contains a first transform module for performing a short time Fourier transform (STFT) on the first loudspeaker signal to obtain a first frequency sub-band signal, a second transform module for performing a short-time Fourier transform (STFT) on the second loudspeaker signal to obtain a second frequency sub-band signal and a third transform module for performing a short-time Fourier transform (STFT) on the microphone output to obtain a third frequency sub-band signal. Further, the system contains a subtractor module for subtracting the first and second frequency sub-band signals from the third frequency sub-band signal to obtain the clean speech signal in the frequency domain. An inverse short-time Fourier transform (ISTFT) module translates the clean speech signal into a time domain.

A still further embodiment of the invention discloses an acoustic echo supression method. The method includes the steps of receiving an input signal containing acoustic echo signals and a clean speech signal, transforming the acoustic echo signals into frequency domain signals, and determining a sum of magnitudes for each of the frequency domain signals. In addition, the method includes the steps of transforming the input signal into a third frequency domain signal, and canceling the echo signals by generating a difference signal between the sum of the magnitudes of the frequency domain signals and the magnitude of the third frequency domain signal. The difference signal is then transformed into a time domain signal to obtain the clean speech signal.

Advantageously, in contrast to the traditional echo suppression systems where the goal is to cancel the interference at the sample level, the proposed system suppresses the interference in the magnitude frequency domain. Therefore, the phase and details of the acoustic transfer functions need not be known with precision such that small changes in the acoustic path characteristics will not result in poor system performance.

### BRIEF DESCRIPTION OF THE DRAWINGS

FIG. 1A is a block diagram of a communication system illustrating the problem of acoustic coupling;

FIG. 1B is block diagram of a system having a filter adapted to estimate the acoustic path between a loudspeaker and a microphone;

FIG. 2 is a block diagram of a multichannel system that enables a user to communicate with a remote user through a data communication channel;

FIG. 3 is a block diagram of a multichannel system in which the first embodiment of the present invention is employed for suppressing echoes and acoustic interferences;

FIG. 4 is a block diagram of a system in accordance with the first embodiment of the present invention, for suppressing interference signals and echoes in a multichannel system of FIG. 3;

FIG. 5 is a block diagram of a system having a frequency channel K, and illustrating the target signal detector for detecting a target signal (speech) in accordance with one embodiment of the present invention; and

FIG. 6 are graphs showing changes in weight trajectories for shakers utilized to resolve the non uniqueness problem.

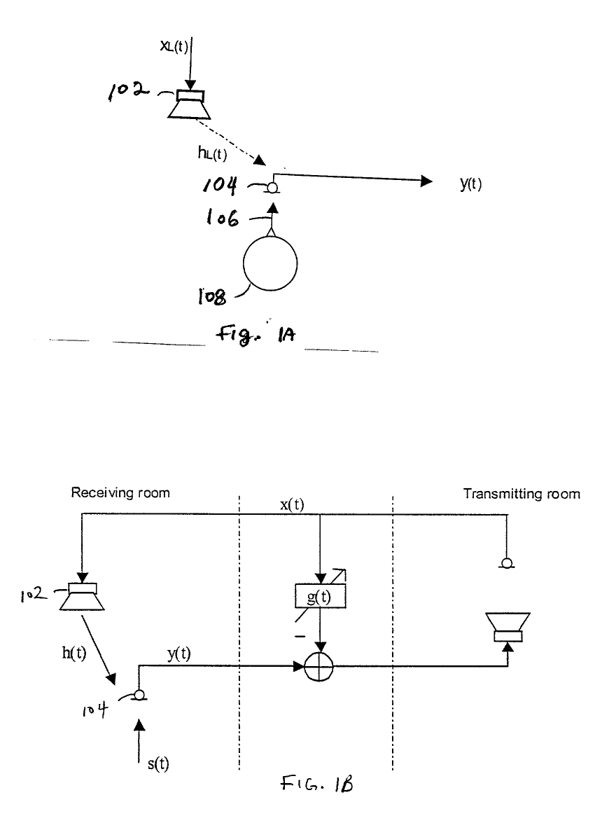

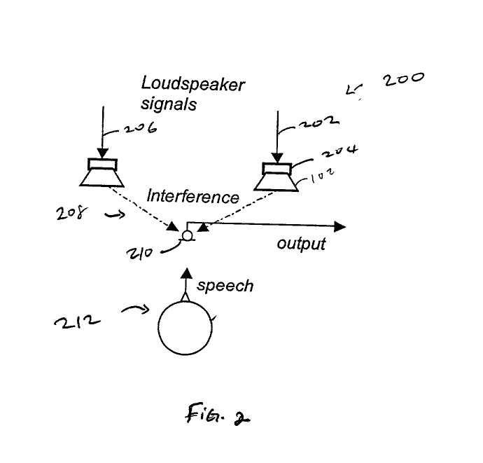

### DETAILED DESCRIPTION OF THE DRAWINGS

A first embodiment of the present invention discloses a system for suppressing acoustic echoes and interferences received by a transducer (e.g., a microphone) when a user transmits a clean speech signal within a multichannel communication system. The system suppresses the acoustic echoes and interference signal from the microphone output signal to produce the clean speech signal. The system contains modules for performing short-time Fourier transform (STFT) on the acoustic echoes and interference signal and the microphone output signal. A subtractor module subtracts frequency sub-band signals obtained for the acoustic echoes and interference signal from those obtained for the microphone output signal to obtain the clean speech signal in the frequency domain.

Thereafter, the clean speech signal is translated into a time domain by the an inverse short-time Fourier transform (ISTFT) module. These and various other aspects of the present invention are described with reference to the diagrams that follow. While the present invention will be described with reference to an embodiment for suppressing acoustic echoes and interferences, one of ordinary skill in the art will realize that other embodiments for attaining the functionality of the present invention are possible.

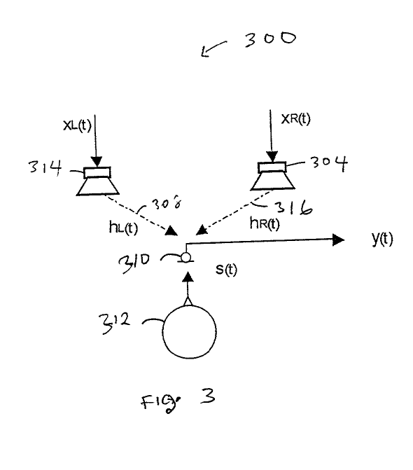

FIG. 3 is a block diagram of a multi-channel system 300 in which a first embodiment of the present invention is employed for suppressing echoes and acoustic interferences. Specifically, multichannel system 300 is a desktop environment comprising a set of loudspeakers 314, 304 for outputting loudspeaker signals x_{L}(t) and x_{R}(t), and a microphone 310 for accepting an input voice stream s(t) from a user 312 and for generating an associated microphone output y(t). As used herein the loudspeaker signals x_{L}(t) and x_{R}(t) may be signals from other type transducers or devices such that the signals are usable as reference signals to determine response of the acoustic paths. Microphone output y(t) comprises the sum of loudspeakers signals x_{L}(t) and x_{R}(t) modified by their acoustic paths h_{L}(t) and h_{R}(t), respectively, in addition to a speech clean input s(t), as illustrated in equation 1, below.

y(t)=x_{L}(t)*h_{L}(t)+x_{R}(t)*h_{R}(t)+s(t). (1)

where y(t) is the microphone output signal, x_{L}(t) is the loudspeaker 314 signal, h_{L}(t) is the acoustic path between loudspeaker 314 and microphone 310, x_{R}(t) is the loudspeaker 304 signal, h_{R}(t) is the acoustic path between loudspeaker 304 and microphone 310, and s(t) is the clean speech signal from user 312.

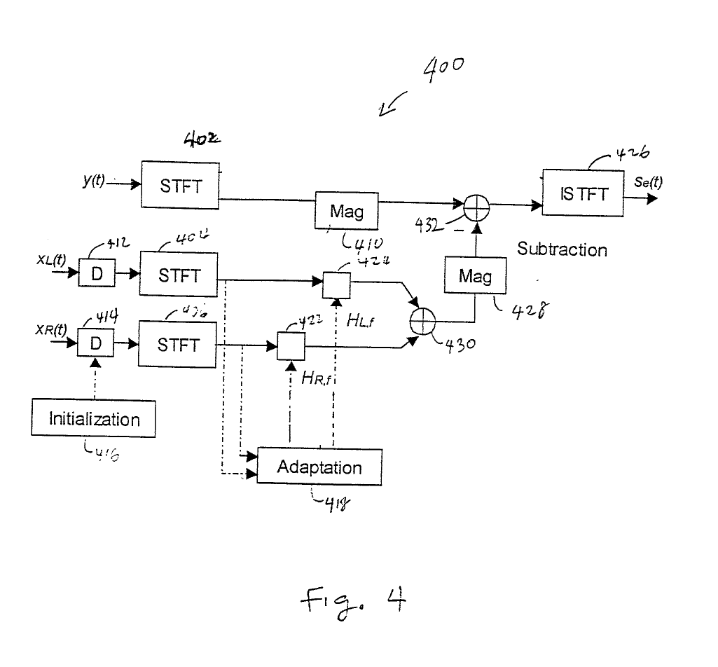

In operation, user 312 communicates with a remote user (not shown) by speaking into microphone 310 and providing a clean speech signal s(t) to be communicated to the remote user. Microphone 310, however, generates a microphone output y(t) which not only includes the clean speech signal s(t) but also an interference signal comprising both x_{L}(t) and x_{R}(t) modified by their acoustic paths. System 300 employs an interference and echo suppressor method that processes y(t) in order to suppress the interference signal and to recover the speech signal s(t) as cleanly as possible. The interference and echo suppressor method involves a number of steps which are more fully described with reference to FIG. 4.

FIG. 4 is a block diagram of a system 400 for suppressing interference signals and echoes in the multichannel system 300 of FIG. 3.

Among other components, system 400 comprises a STFT (short-time Fourier transform) module 402 for computing the short time Fourier transform of microphone output y(t) to yield a number of frequency sub-band signals each having a magnitude 410 and a phase (not shown), delay modules 412, 414 for synchronizing loudspeaker signals x_{L}(t) and x_{R}(t) with a microphone output signal, STFT modules 404, 406 for computing the short-time Fourier transform of loudspeaker signals x_{L}(t) and x_{R}(t) to yield a number of frequency sub-band signals each having a magnitude and a phase, filters 424, 422 for modifying the loudspeaker signals according to transfer functions H_{L,f} H_{R,f}, respectively, an adder 430 for summing the magnitude of each of the frequency sub-band signals of the loudspeaker signals to obtain a magnitude 428 of the interference signal, a subtractor 432 for subtracting the interference signal from magnitude 410 of microphone output signal y(t); and an ISTFT (inverse short-time Fourier transform) for obtaining an inverse short-time Fourier transform of the clean speech signal s(t).

In operation, as noted, microphone output y(t) not only includes the clean speech signal s(t) but also the interference signal comprising both x_{L}(t) and x_{R}(t) modified by their acoustic paths. Briefly, system 400 suppresses the interference signal by estimating a magnitude of the short-time transform of the interference signal, and subtracting the magnitude from the short-time magnitude of the microphone output signal y(t). After subtraction, the clean speech s(t) is estimated in the time-domain speech by an inverse short-time transform, using the modified short-time magnitude and the original short-time phase of microphone output signal y(t). Thus the algorithm can be divided into two parts, one that estimates the magnitude of the interference signal, and one that modifies the microphone output signal based on this estimate to derive the clean speech s(t). The process of suppression employs a number of steps, namely, (1) system initialization, (2) system adaptation or calibration, (3) suppression, (4) and resynthesis.

System Initialization

Many hardware and/or software components typically cause a delay when a signal is passed by the components. Hence, the function of the system initialization step is to estimate a system delay “D” due to either hardware and/or software. Delay modules 404 and 406 adjust inputs to system 400 according to this delay in order to maintain synchrony between the microphone output signal and the loudspeaker signals.

Adaptation

The adaptation step comprises detecting non-speech intervals with a voice activity detector (VAD), and obtaining, as well as updating, estimates H_{L,f}(t) and H_{R,f}(t). of the acoustic coupling using the outputs x_{L}(t) and x_{R}(t) from the loudspeakers. This is done during intervals where no input speech (target signal) is present. A voice activity detector monitors the presence of these intervals and sends control signals to an adaptive algorithm.

In one embodiment, the adaptive algorithm is the Simplified Recursive Least Squares (SRLS) modified to handle the multichannel case.

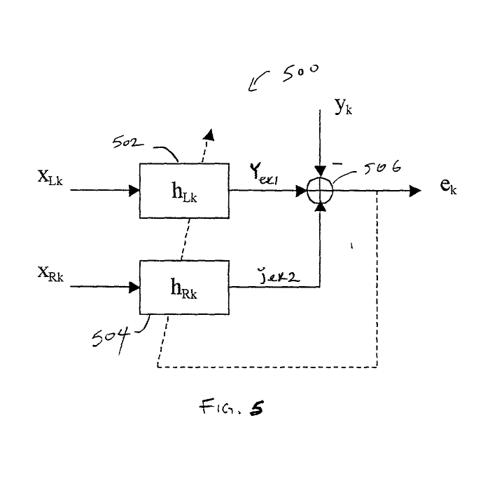

A first embodiment of the VAD (voice activity detector) is a target signal detector (TSD). The TSD employs a method of detecting the target signal (speech signal), which makes no assumption about the characteristics of the signal, and which relies only on the knowledge and availability of the loudspeaker signals. The TSD will be described with reference to FIG. 5.

System Calibration

In an alternate embodiment, the system may be calibrated to generate a first estimate of the acoustic coupling of acoustic paths 308, 316 so that filters H_{L,f}(t) and H_{R,f}(t) representing the estimate may be computed. The step includes generating calibration signals x_{L}(t) and x_{R}(t) through loudspeakers 314 and 304 (FIG. 3). In one embodiment, the calibration signals consist of uncorrelated white noise sequences delivered simultaneously from each loudspeaker. After generation, the calibration signals x_{L}(t) and x_{R}(t) are directed toward microphone 310 to produce microphone output y(t). During this step, the user does not speak so that s(t)=0. Therefore, microphone output y(t) consists of the sum of calibration signals x_{L}(t) and x_{R}(t) as well as the acoustic responses of their respective acoustic paths. In an alternate embodiment, the present invention employs software running on a computing device having a full-duplex sound card.

The computing device may be a conventional personal computer or computer workstation with sufficient memory and processing capability to handle high-level data computations. For example, a personal computer having a Pentium® III available from Intel® or an AMD-K6® processor available from Advanced Micro Devices may be employed. Of course, the processing power may be obtained from a dedicated processor, such as a DSP (Digital Signal Processor) or the like.

After microphone output y(t) is received, the short-time transforms of both calibration signals x_{L}(t) and x_{R}(t), and the filters H_{L,f}(t) and H_{R,f}(t) are computed as follows. In the absence of speech equation (1) in the short-time frequency domain is written as:

Y(t,f)=x_{L}(t,f)* H_{L,f}(t)+x_{R}(t,f)*H_{R,f}(t), (2)

It should be noted that filters 424 (H_{L,f}(t)) and 422 (H_{R,f}(t)) represent the effect of their respective acoustic paths. Assuming that each sub-band is independent we can estimate these two filters at each sub-band, separately. Since x_{L}(t,f) and x_{R}(t,f) are known and uncorrelated during calibration (by design), the filters can be estimated solving a least squares problem. To improve robustness to overall delay changes and keep the reference signals correctly synchronized, the filters are non-causal, i.e., past and future frames are observed to compute the current parameter values. The current embodiment examines one frame in the past and one in the future to estimate the current value (3 taps per frequency band). Computing the effects of the channel in this way is advantageous since the subtraction is performed in the frequency domain. The calibration step is implemented once and its results remain valid so long as significant changes to the acoustic paths do not occur.

Suppression

The suppression step uses the obtained estimate of the acoustic coupling to compute an estimate of the short-time magnitude of the interference at each frame. This estimate can be obtained in various ways, as described below. Once obtained, the estimate of the interference is subtracted from the short-time magnitude of y(t). A memory-less nonlinearity is applied prior to subtraction and the inverse of this function is applied to the result. Thereafter, the step includes clipping the possible negative values of the magnitude estimate. A spectral subtraction process is applied to suppress the effect of the interference. The spectral subtraction process is a well-known technique and need not be discussed in detail.

The estimate of the short-time magnitude of the interference at each frame interference is obtained by filtering the sub-band signals of the loudspeaker signals with the estimates HL,f(t) and HR,f(t). After filtering, the results are either added before or after magnitude computation. These two estimates have different behaviors. The sum of the magnitudes is always larger than the magnitude of the sum, thus using this estimate will over-estimate the interference, which leads to more robustness but inferior quality. In the current mode of operation, either of the two methods may be selected, depending on the desired quality and tolerance to residual interference. Generally, spectral subtraction can be carried out in a nonlinear domain. After subtraction, the inverse nonlinearity is applied to the result. For example, the short-time magnitude at the speech estimate will be computed as

|Sₑ(t,f)|=|[Y(t,f)]^{α}−β[Ye(t,f)]^{α}|^{(1/α)} (3)

where |Sₑ(t,f)| is the normalized short-time magnitude of the speech, [Y(t,f)]^{α} is the STFT of Y(t), and β[Ye(t,f)]^{α}|^{(1/α)} is an estimate of STFT of Y(f) α is a parameter such that if α<1, the processing is performed in a compressed domain and this has the effect that segments with low signal-to-interference ratio (SIR) will be compressed more and subtracted more than regions of high SIR, and β is a parameter that determines the amount of suppression. In one embodiment, the values of α=0.8 and β=1 yielded more desirable results. These values, however, are exemplary and not intended to be limiting, as other values of α and β may be employed.

Resynthesis

The resynthesis step involves using the short-time phase of y(t) and the short-time magnitude of the clean speech signal in the frequency domain to reconstruct the estimate of the clean speech signal sₑ(t), by inverse short-time transform. Next, a band-pass filter (70 Hz<f<8 kHz) is applied to sₑ(t) to remove out-of-band residuals.

Target Signal Detector and Signal Decorrelation

FIG. 5 is a block diagram of a system 500 having a frequency channel K, and illustrating the target signal detector for detecting a target signal (speech) in accordance with one embodiment of the present invention.

Subchannel K comprises filters 502, 504 representing an estimate of the acoustic responses h_{Lk} and h_{Rk} in frequency channel K, filters 502, 504 receiving loudspeaker signals x_{Lk}, x_{Rk}, subtractor 506 for subtracting interference estimates yₑₖ₁, yₑₖ₂ from the microphone output signal yₖ, and the error eₖ between the microphone input yₖ and the interference estimates yₑₖ₁, yₑₖ₂.

After the adaptation (or calibration) step has been performed, the filters h_{Lk} and h_{Rk} represent an estimate of the acoustic responses in frequency channel K. In the absence of the target signal, when the user not speaking, (s(t)=0), the error eₖ between the microphone input yₖ and the interference estimate yₑₖ is very small (ideally zero), where the interference estimate is given by yₑₖ=x_{Lk}*h_{Lk}+x_{Rk}*h_{Rk}. The total error eₖ at the output system will consist of the sum of the errors, i.e. E=Σₖ eₖ. Three possible situations will cause this total error to increase namely, (1) the target signal is present and the acoustic environment has not changed, (2) no target signal is present but the acoustic environment has changed, and (3) the target signal is present and the acoustic environment has changed.

Since the adaptation occurs only during non-speech intervals, adaptation is performed when condition (2) occurs. It should be observed that the value E is not employed as a criterion for deciding when to perform or discontinue the adaptation process. However, if the adaptive algorithm could be fast enough to track changes in the acoustics, the error under condition (2) would be smaller compared to errors under conditions (1) and (3), and would be a reliable target signal indicator. One technique for enabling the adaptive algorithm to track changes faster is to increase its forgetting factor. That is, disregarding the longer-term statistics, which causes the acoustic path estimates to be very noise and unreliable.

If the values of h_{Lk} and h_{Rk} using information within a very short time window (1-3 frames) were estimated, the instantaneous error may be driven to zero during condition (2). But the values of h_{Lk} and h_{Rk} would change drastically from frame to frame, depending on the current values of the loudspeaker signals. While this fast algorithm would perform poorly during intervals of target signal activity (since the acoustic path estimate are erroneous), it accurately detects target signal activity. Therefore, in a first embodiment, this fast algorithm runs simultaneously with the RLS algorithm, the fast algorithm being used to control the behavior of the RLS algorithm.

Fast Adaptive Algorithm

At each frequency band, the error between the microphone signal yₖ(n) and an estimate yₑₖ(n) derived as the sum of the loudspeaker signals in that frame is minimized, each multiplied by a gain factor:

yₑₖ(n)=x_{Lk}(n) g_{Lk}(n)+x_{Rk}(n) g_{Rk}(n),

where the gains are obtained by solving a system of linear equations involving three frames of the loudspeaker signals, i.e.

gk=[g_{Lk}(n) g_{Rk}(n)]^{T}=R⁻¹r

with

R=x^{H}x,

X=[x_{L} x_{R}],

x_{L}=[x_{Lk}(n−1) x_{Lk}(n) x_{Lk}(n+1)]^{T},

x_{R}=[x_{Rk}(n−1) x_{Rk}(n) x_{Rk}(n+1)]^{T},

and

r=x^{H}y,

y=[yₖ(n−1) yₖ(n) yₖ(n+1)]^{T}.

This is equivalent to solving a one-tap Wiener filter using very short-term statistics (3 frames). When the target signal is present and has significant energy in band k, the estimate yₑₖ(n) is inaccurate. Otherwise, the estimate is high accurate. The complexity of this algorithm is medium, since it requires the computation of an outer product and the inversion of a [2×2] matrix, but this is done at each frame and every subband. The algorithm takes advantage of the buffering and data structure already implemented for the RLS algorithm.

Metrics are used to determine the accuracy of the estimate generated by the fast algorithm. One metric is to compute the correlation coefficient between the spectral estimate and the microphone input for a range of frequencies from 200 Hz to 10 kHz. The correlation coefficient is computed on the complex sequences representing the STFT of estimate and microphone input. In one sense, it is a similarity measure between these two sequences of complex numbers. After the similarity measure is computed, a hysteresis detector is applied to decide if the target signal is present. The values of the thresholds were set based on experimental observation (ThL=0.96 and ThH=0.99). Improved detection may be obtained by setting temporal thresholds.

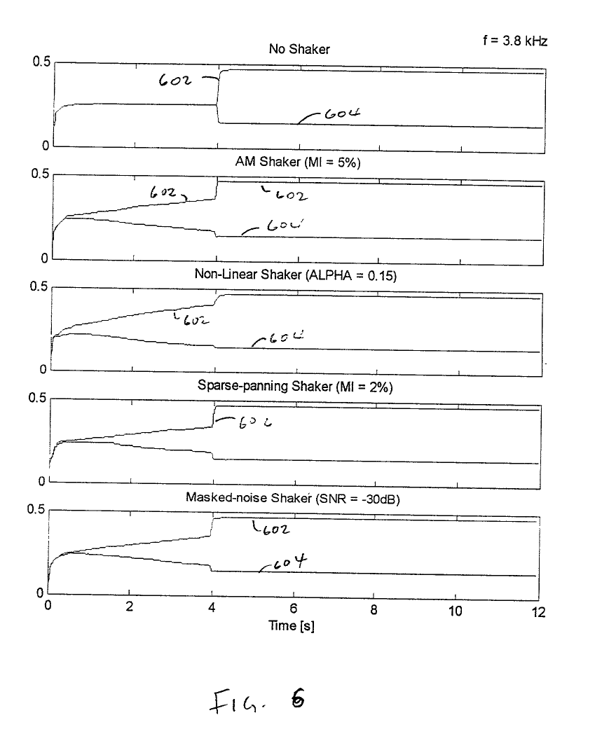

FIG. 6 are graphs showing changes in weight trajectories for shakers utilized to resolve the non uniqueness problem. As noted, non-uniqueness problem (NUP) in channel identification affects the performance of multi-channel acoustic echo cancelers. The problem appears only when there is some correlation among the loudspeaker signals. Thus, a way of reducing the problem is to de-correlate these outputs. One approach for resolving this problem is to distort or perturb the loudspeaker signals in such a way as to reduce their correlation.

This is acceptable as long as the distortion is not audible. The perturbation methods are referred to as “shakers” for de-correlating the loudspeaker signals. Typically, audio materials delivered by loudspeakers can be either stereo or panned mono. If the system has adapted to a mono signal, the abrupt change to a stereo signal will result in a small period of increased interference (due to the mismatch between the true paths and the previous incorrect solution.). The present embodiment has a fast adaptation rate and is unaffected by this problem. Nevertheless, various embodiments of shakers will be disclosed.

Experiments

The present experiments consist of running a panned mono signal, followed by a stereo signal, and back to a mono signal within system 300 (FIG. 3). To obtain maximum correlation during the first “mono” section, a White Gaussian Noise sequence with duration of 4 seconds was employed. After the first mono signal, a stereo signal with two independent WGN sequences (maximally de-correlated) were utilized for 4 seconds, then switched back to the mono condition. The various shakers were applied to these test signals in order to obtain the loudspeaker signals. To simulate the acoustic paths we employed two 5^{th}-order IIR filters with smooth frequency responses. The loudspeaker signals x_{L}(t) and x_{R}(t) were numerically convolved with their respective paths and added together to simulate the microphone input.

The microphone input was then processed within system 300. The system parameters used were λ=0.99, α=1, β=1, and 3-tap long sub-band temporal filters. For each shaker condition, the weight trajectories and the residual signal were computed. The result of using the different shakers was obtained analyzing the weight trajectories and the residual interference.

Shakers

Four different shakers were used in this experiment. The following is a list of the shakers and the parameters used. These parameters were selected by processing speech and music samples until the distortion became in-perceptible.

1) Amplitude modulation: modulate carrier with x(t) (a=0.05 and f=32.5 Hz).

x_{L}(t)=x(t) [1+a cos(2πf_{L}t)] and x_{R}(t)=x(t) [1+a sin(2πf_{R}t)]

2) Non-linear distortion: half-wave rectification (α=0.15)

x_{L}(t)=x(t) [1+α rect(x(t))] and x_{R}(t)=x(t) [1−α rect(−x(t))]

3) Random panning: pan mono signal at random intervals (a=0.02).

x_{L}(t)=x(t) [1+a] and x_{R}(t)=x(t) [1−a]

4) Additive masked noise: add masked noise at −30 dB SNR level

x_{L}(t) x(t)+n_{L}(t) and x_{R}(t)=x(t)+n_{R}(t)

Results

The first evaluation consisted of observing the change in the weight trajectories when the audio was switched from mono/stereo/mono (FIG. 6). FIG. 6 shows the trajectory of the center taps of the left 602 and right 604 sub-band temporal filters at a designated sub band (f=3.8 kHz). Similar results were observed at all other sub-bands. In this experiment, it is assumed that the true values of the coefficients were attained after the first 5 seconds, since the maximally de-correlated signal started at t=4 s.

In all cases, it was observed that the weights did not reach their true value during the first four seconds, the monaural case. When no shaker was added, it was observed that the left and right coefficients were identical, and equal to the average of the true left and right values. However, when a shaker was included, the weights moved toward the true values, although not reaching them completely. All of the shakers showed somewhat comparable performance and this same trend was observed at all frequencies. It is also interesting to note, that after the weights reached the true values and the loudspeaker signals were switched back to panned mono, the weights remained in the correct location, even without shaker. Therefore, the three new linear shakers disclosed are somewhat comparable to the non-linear technique.

Advantageously, unlike conventional AEC systems, the present invention functions in a domain other than the time domain so that robustness to small changes in the acoustic responses and better stability during estimation of acoustic responses are achieved.

Further, the control of sound quality vs. suppression based on parameter selection (α, β, etc.) is possible. In addition, small filters result in low-dimension matrices with better condition numbers, and sub-band architecture allows frequency-selective processing. Also, the present invention permits an analysis stage compatible with other algorithms (additive noise suppression, reverberation reduction, etc.).

In this manner, the present invention provides a system for suppressing multi-channel acoustic echoes and interferences. While the above is a complete description of exemplary specific embodiments of the invention, additional embodiments are also possible. The present invention is not limited to stereophonic systems with two loudspeakers, and can include multiple loudspeakers receiving signals from multiple communication channels. Signals may be transmitted through one or more communication channels for output by two or more loudspeakers. Moreover, the present invention is applicable to a single desktop environment such as when a user is interacting with the desktop environment during a game session, for example.

Therefore, the above description should not be taken as limiting the scope of the invention, which is defined by the appended claims along with their full scope of equivalents.

What is claimed is:

1. A method for suppressing an interference signal from a microphone output signal to produce a clean speech signal, the interference signal being first and second loudspeaker signals modified by first and second acoustic paths through which the loudspeaker signals reach a microphone, the interference signal combining with the clean speech signal to form the microphone output signal, the method comprising:
determining an acoustic response for each of the first and second acoustic paths in a frequency domain;
determining an estimate of the interference signal in a frequency domain using the acoustic response for each of the first and second acoustic paths;
suppressing the estimate of interference signal from the microphone output signal to obtain the clean speech signal in the frequency domain; and
translating the clean speech signal into time domain.

2. The method of claim 1 further comprising estimating a delay for synchronizing the microphone output signal with the first and second loudspeaker signals.

3. The method of claim 1 wherein the clean speech signal contains pauses of nonspeech intervals, and the step of determining the acoustic response is performed during a pause.

4. The method of claim 1 further comprising decorrelating the first and second loudspeaker signals prior to the step of determining an acoustic response.

5. The method of claim 1 wherein the step of determining an estimate of the interference signal comprises decomposing each of the first and second loudspeaker signals into first and second frequency signals, respectively.

6. The method of claim 5 further comprising modifying the first frequency signal by the acoustic response of the first acoustic path to obtain a first interference estimate.

7. The method of claim 6 further comprising modifying the second frequency signal by the acoustic response of the second acoustic path to obtain a second interference estimate.

8. The method of claim 7 further comprising combining the first interference estimate and the second interference estimate to obtain a magnitude of the interference signal.

9. The method of claim 8 wherein the step of suppressing the interference signal comprises subtracting the magnitude of the interference signal from a magnitude of the microphone output signal.

10. The method of claim 1 wherein the step of determining an acoustic response comprises generating a sequence of white noise signals for output through the first and second loudspeakers.

11. In a communication system having a transducer for receiving a clean speech signal from a user, and having first and second loudspeakers for providing an output signal to the user, the output signal containing first and second loudspeaker signals which interfere with the clean speech signal traveling through first and second acoustic paths to reach the transducer, the transducer receiving an input signal containing the first and second loudspeaker signals and the clean speech signal, a method of obtaining the clean speech signal, the method comprising:
performing a short-time Fourier transform (STFT) on the input signal to obtain at least one frequency component;
performing a short-time Fourier transform (STFT) on the first and second loudspeaker signals to obtain first and second frequency components, respectively;
summing the first and second frequency components to obtain an interference sum; and
subtracting the interference sum from the at least one frequency component to obtain the clean speech signal for translation into a time domain.

12. The system of claim 11 further comprising modifying the first frequency component with a transfer function of the first acoustic path, prior to the step of summing the first and second frequency components.

13. The system of claim 12 further comprising modifying the second frequency component with a transfer function of the second acoustic path, prior to the step of summing the first and second frequency components.

14. In a communication system having a local microphone for transmitting signals to a remote user through a communication channel, and first and second local loudspeakers for receiving signals from the remote user via the communication channel, the microphone receiving a microphone output signal comprising a clean speech signal from a local user and an interference signal from the first and second loudspeakers, a system for suppressing the interference signal, the system comprising:
a first transform module performing a short-time Fourier transform (STFT) on the first loudspeaker signal to obtain a first frequency sub-band signal;
a second transform module performing a short-time Fourier transform (STFT) on the second loudspeaker signal to obtain a second frequency sub-band signal;
a third transform module performing a short-time Fourier transform (STFT) on the microphone output signal to obtain a third frequency sub-band signal;
a subtractor module subtracting the first and second frequency sub-band signals from the third frequency sub-band signal to obtain a clean speech signal; and
an inverse short-time Fourier transform (ISTFT) module translating the clean speech signal into time domain.

15. The system of claim 14 further comprising a filter module modifying the first frequency sub-band signal using an acoustic response of the first acoustic path, and for modifying the second frequency sub-band signal using an acoustic response of the second acoustic path.

16. The system of claim 14 further comprising an adder for summing the first and second frequency sub-band signals to obtain a magnitude of an interfering signal.

17. The method of claim 14 further comprising an adaptation module estimating an acoustic response of the first acoustic path, and for estimating an acoustic response of the second acoustic path.

18. An acoustic echo suppression method comprising:
receiving an input signal containing first and second acoustic echo signals and a clean speech signal;
transforming the first and second acoustic echo signals into first and second frequency domain signals;
determining a sum of magnitudes for each of the first and second frequency domain signals;
transforming the input signal into a third frequency domain signal;
determining a sum for the magnitude of the first frequency domain signal and the second frequency domain signal;
determining a magnitude of the third frequency domain signal; and
canceling the first and second echo signals by generating a difference signal between the sum of the magnitudes for each of the first and second frequency domain signals and the magnitude of the third frequency domain signal, the difference signal being transformed into a time domain signal to obtain the clean speech signal.

19. The method of claim 18 further comprising estimating a delay for synchronizing the microphone output signal with the first and second loudspeaker signals.

20. The method of claim 18 wherein the step of determining a sum of magnitudes for each of the first and second frequency domain signals further comprises obtaining an acoustic response of first and second acoustic paths.

21. The method of claim 18 further comprising modifying the first echo signal by the acoustic response of the first acoustic path to obtain a first interference estimate for the first loudspeaker signal, and modifying the second frequency signal by the acoustic response of the second acoustic path to obtain a second interference estimate for the second loudspeaker signal.

22. The method of claim 1 wherein the step of determining the acoustic response comprises generating a sequence of white noise signals for output through the first and second loudspeakers.

23. The method of claim 4, wherein the step of decorrelation is carried out by any one or more of amplitude modulation, random panning and adding additive noise.
